(19) United States
(12) Patent Application Publication
(10) Pub. No.: US 2015/0136293 A1
(43) Pub. Date: May 21, 2015

(54) SAFETY WARNING TIRE

(71) Applicant: SUNTOP ENTERPRISE CO., LTD., Tainan City (TW)

(72) Inventor: Yung-Shiang CHENG, Tainan City (TW)

(21) Appl. No.: 14/538,898

(22) Filed: Nov. 12, 2014

(30) Foreign Application Priority Data
Nov. 20, 2013 (TW) 102221710

(51) Int. Cl. B60C 13/00

(52) U.S. Cl. CPC B60C 13/001
USPC 152/524

(57) ABSTRACT

A safety warning tire for a vehicle includes: a tire body and at least one warning unit. The tire body has an annular tread portion adapted to contact a road surface, and two annular sidewalls respectively connected to two opposite sides of the annular tread portion. The annular tread portion has a tread surface. The tread surface has an annular contact surface region adapted to contact the road surface, and two annular non-contact surface regions respectively connected to two opposite sides of the annular contact surface region. The at least one warning unit is disposed on one of the annular non-contact surface regions and outer surfaces of the two annular sidewalls, and includes an annular coating layer that extends annularly along a circumference of the tire body.

### CROSS-REFERENCE TO RELATED APPLICATION

This application claims priority of Taiwanese Utility Model Application No. 102221710, filed on Nov. 20, 2013.

### FIELD OF THE DISCLOSURE

The present disclosure relates to a tire, more particularly to a tire adapted to be installed on a wheel of a bicycle and having warning function.

### BACKGROUND OF THE DISCLOSURE

For the sake of safety, a bicycle generally has a light reflector, such as a reflective board, strip or sticker, attached to at least one wheel spoke, so as to reflect light for giving a warning to nearby vehicles under poor visibility conditions brought about by, e. g., twilight, nightfall, mist or rain, etc. The conventional light reflector installed on the wheel spoke has s an insufficient thickness and does not protrude from a tire engaged with the wheel spoke, such that drivers or riders of vehicles ahead of or behind the bicycle are unable to see the light reflected by the light reflector, and thus the effect of warning is hardly realized.

### SUMMARY OF THE DISCLOSURE

Therefore, the object of the present disclosure is to provide a safety warning tire for a vehicle that is adapted to give a warning to people ahead of or behind the vehicle.

Accordingly, a safety warning tire for a vehicle includes: a tire body and at least one warning unit. The tire body has an annular tread portion adapted to contact a road surface, and two opposite annular sidewalls respectively connected to two opposite sides of the annular tread portion. The annular tread portion has a tread surface. The tread surface has an annular contact surface region adapted to contact the road surface, and two annular non-contact surface regions respectively connected to two opposite sides of the annular contact surface region. The at least one warning unit is disposed on one of the annular non-contact surface regions and outer surfaces of the two annular sidewalls, and includes an annular coating layer that extends annularly along a circumference of the tire body.

### BRIEF DESCRIPTION OF THE DRAWINGS

Other features and advantages of the present disclosure will become apparent in the following detailed description of the embodiments with reference to the accompanying drawings, of which:

FIG. 1 is a perspective view of the first embodiment of a safety warning tire according to the present disclosure;

FIG. 2 is a front view of the first embodiment;

FIG. 3 is a sectional view of the first embodiment;

FIG. 4 is a fragmentary cutaway perspective view of the second embodiment of the safety warning tire according to the present disclosure;

FIG. 5 is a front view of the second embodiment; and

FIG. 6 is a sectional view of the second embodiment.

### DETAILED DESCRIPTION OF THE EMBODIMENT

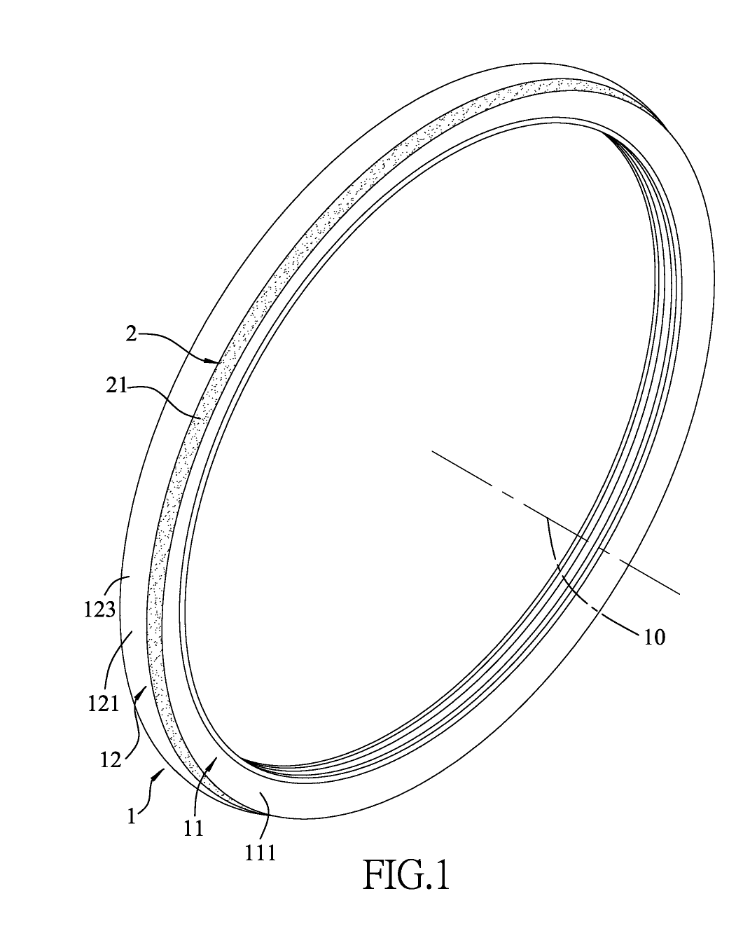

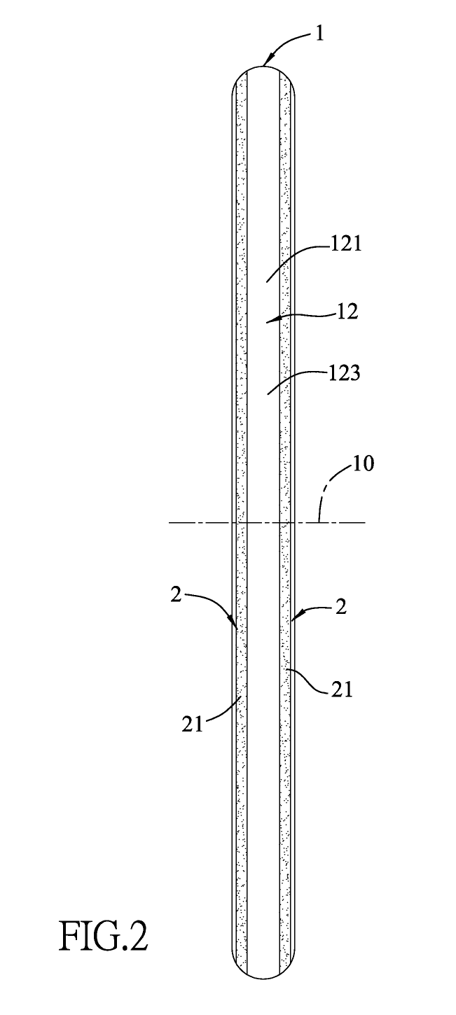

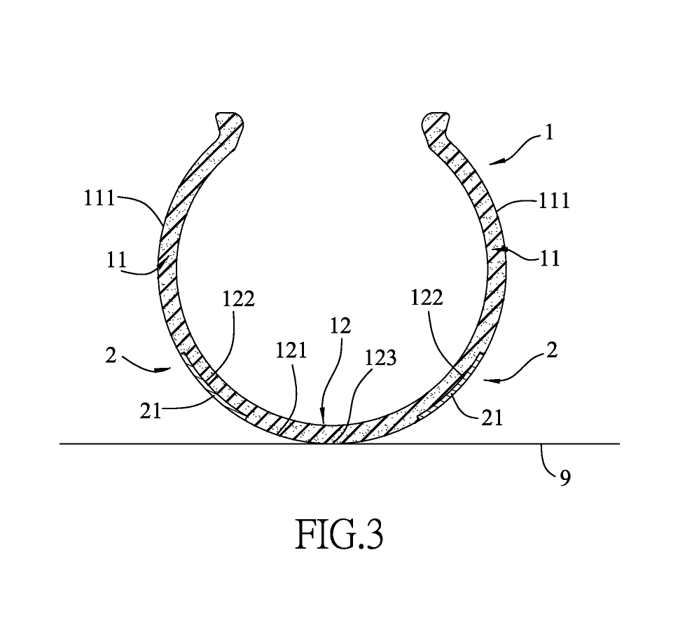

Referring to FIGS. 1, 2 and 3, the first embodiment of a safety warning tire according to the present disclosure is adapted to be installed on a wheel. The wheel has an annular rim (not shown) and the safety warning tire is circumferentially mounted on the wheel so as to travel on a road surface 9. In this embodiment, the safety warning tire is unlimitedly exemplified as a bicycle tire and can be varied by a skilled artisan based on the actual application.

The safety warning tire includes a tire body 1 and at least one warning unit 2. In this embodiment, two warning units 2 are included. The tire body 1 is annular and is formed with an annular air-inflating groove that surrounds a central axis 10 so that the cross section of the tire body 1 is formed as C-shape or U-shape. The tire body 1 has an annular tread portion 12 adapted to contact the road surface 9, and two opposite annular sidewalls 11 respectively connected to two opposite sides of the annular tread portion 12. The annular tread portion 12 cooperates with the two opposite annular sidewalls 11 to define the annular air-inflating groove. The annular tread portion 12 has a tread surface 121. The tread surface 121 of the annular tread portion 12 has an annular contact surface region 123 adapted to contact the road surface 9, and two annular non-contact surface regions 122 respectively connected to two opposite sides of the annular contact surface region 123. Each of the two opposite annular sidewalls 11 has an outer surface 111 connected to a corresponding one of the annular non-contact surface regions 122. Each annular non-contact surface region 122 is formed with an outward opening annular groove extending along the circumference of the tire body 1. The tread surface 121 may be formed with a tread pattern composed of protrusions alternately placed with grooves (not shown) for tire sliding/wear prevention.

The warning units 2 may be disposed on the annular non-contact surface regions 122 or the outer surfaces 111 of the two opposite annular sidewalls 11. In this embodiment, each of the two warning units 2 is disposed on a corresponding one of the annular non- contact surface regions 122 and includes an annular coating layer 21 extending annularly along a circumference of the tire body 1. The annular coating layer 21 may be a reflective coating layer or a fluorescence coating layer. For instance, the annular coating layer 21 may be formed of a reflective fabric with light reflection or fluorescence emission function.

When the safety warning tire is fabricated, the annular coating layers 21 of the warning units 2 may be applied to a blank of the tire body 1 and then molded together in a mold by hot pressing so as to form the tire body 1 with the annular coating layers 21. After the mold is released, the annular coating layers 21 will form a smooth surface together with the annular non-contact surface regions 122 and the outer surfaces 111. Each of the annular coating layers 21 is embedded into the outward opening annular groove of a corresponding one of the annular non-contact surface regions 122. Alternatively, the annular non-contact regions 122 may have a smooth surface and the annular coating layers 21 are coated thereon in a thin film form.

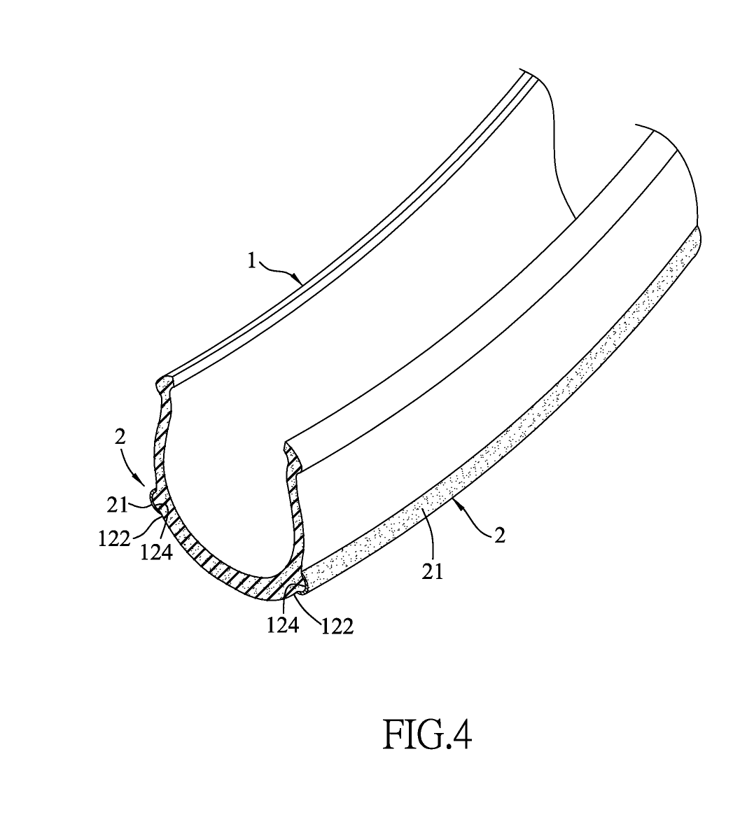

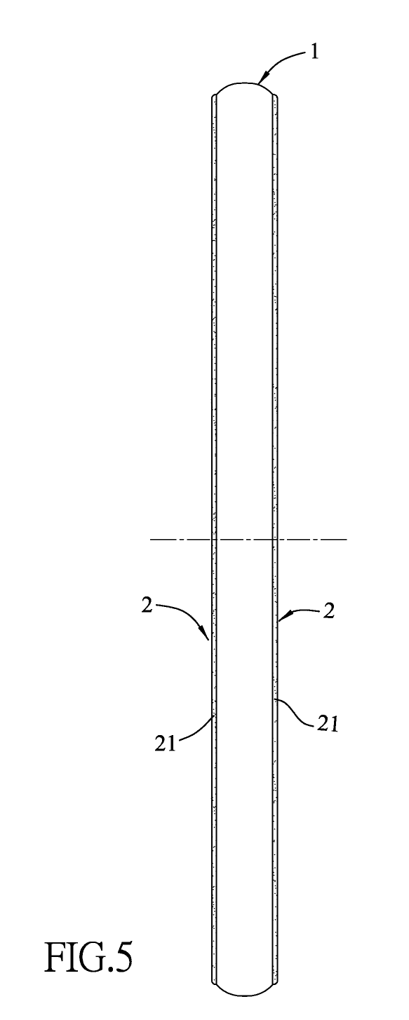

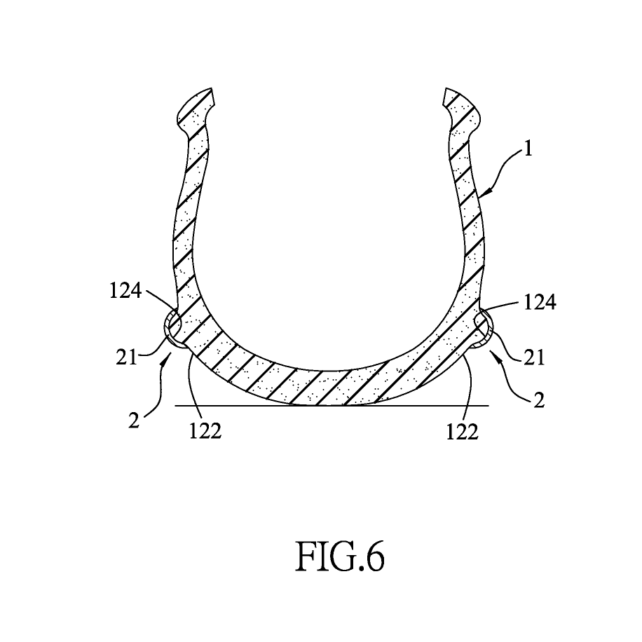

FIGS. 4, 5 and 6 depict the second embodiment of a safety warning tire according to this disclosure. The difference of the second embodiment from the first embodiment is the shape of the annular non-contact surface regions 122. Each annular non-contact surface region 122 is formed with an annular protrusion 124 extending annularly along the circumference of the tire body 1. The two annular coating layers 21 of the warning units 2 respectively cover the annular protrusions 124.

In the embodiments shown in the drawings, the annular coating layers 21 of the warning units 2 are exemplarily shown to be respectively disposed on the annular non-contact surface regions 122 of the annular tread portion 12. However, the annular coating layers 21 may have other arrangements, such as being respectively disposed on one of the annular non-contact surface regions 122 and one of the two opposite annular sidewalls 11, or being respectively disposed on the outer surfaces 111 of the two opposite annular sidewalls 11.

When driving a vehicle installed with the safety warning tire of this disclosure, the light emitted from vehicle lamps of nearby vehicles will be reflected by the warning units 2, and the drivers of the nearby vehicles, including those in ahead of or behind the vehicle, will be given a warning. Furthermore, when the vehicle is driven in the poor visibility conditions brought about by twilight, nightfall, mist or rain, etc., the visibility of the vehicle installed with the safety warning tire of this disclosure with respect to the nearby vehicles is improved.

While the present disclosure has been described in connection with what are considered the most practical embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A safety warning tire for a vehicle, comprising:
a tire body having an annular tread portion adapted to contact a road surface, and two opposite annular sidewalls respectively connected to two opposite sides of said annular tread portion, said annular tread portion having a tread surface, said tread surface having an annular contact surface region adapted to contact the road surface, and two annular non-contact surface regions respectively connected to two opposite sides of said annular contact surface region; and
at least one warning unit disposed on one of said annular non-contact surface regions and outer surfaces of said two opposite annular sidewalls, and including an annular coating layer that extends annularly along a circumference of said tire body.

2. The safety warning tire as claimed in claim 1, wherein said annular coating layer of said at least one warning unit is disposed on one of said annular non-contact surface regions.

3. The safety warning tire as claimed in claim 2, wherein said at least one warning unit includes two warning units, said annular coating layers of said warning units being respectively disposed on said annular non-contact surface regions.

4. safety warning tire as claimed in claim 2, wherein said one of said annular non-contact surface regions is formed with an annular protrusion extending annularly along the circumference of said tire body, said annular coating layer of said at least one warning unit covering said annular protrusion.

5. The safety warning tire as claimed in claim 1, wherein said at least one warning unit includes two warning units, said annular coating layers of said warning units being respectively disposed on one of said annular non-contact surface regions and one of said two opposite annular sidewalls.

6. The safety warning tire as claimed in claim 1, wherein said annular coating layer of said at least one warning unit is disposed on one of said outer surfaces of said two opposite annular sidewalls.

7. The safety warning tire as claimed in claim 6, wherein said at least one warning unit includes two warning units, said annular coating layers of said warning units being respectively disposed on said outer surfaces of said two opposite annular sidewalls.

8. The safety warning tire as claimed in claim 1, wherein said annular coating layer is a reflective coating layer.

9. The safety warning tire as claimed in claim 1, wherein said annular coating layer is a fluorescence coating layer.
